(19) United States
(12) Patent Application Publication
(10) Pub. No.: US 2013/0041808 A1
(43) Pub. Date: Feb. 14, 2013

(54) DISTRIBUTED MEDIA ACCESS

(71) Applicants: Nathalie Pham, Houston, TX (US); Muhammad Zakria, Faisalabad (PK)

(72) Inventors: Nathalie Pham, Houston, TX (US); Muhammad Zakria, Faisalabad (PK)

(21) Appl. No.: 13/269,614

(22) Filed: Oct. 9, 2011

Related U.S. Application Data
(63) Continuation-in-part of application No. 13/136,800, filed on Aug. 10, 2011.

(51) Int. Cl. G06Q 20/22; G06F 15/16

(52) U.S. Cl. 705/39; 709/217

(57) ABSTRACT

Delivering dynamic media content to a client on a client device. The method includes storing segments at a series of data server units; delivering to a client a playlist indicating the playback order, wherein the playlist is configured to be natively processed by the client, whereby the native processing directs the client to: initiate requests for the individual segments to corresponding data server units according to the playback order; download the respective individual segments from the corresponding data server units according to the playback order; and render the respective individual segments according to the playback order so as to render a reconstitution of the dynamic media content; sending each respective individual segment from its respective data server unit to the client device according to a playback order of the playlist. The system includes dynamically scalable architecture for delivery of real-time video packet data sent over a communication network.

### PRIORITY

This application is a continuation-in-part of U.S. patent application Ser. No. 13/136,800, filed Aug. 10, 2011, which is hereby incorporated by reference and made a part of the present disclosure.

### BACKGROUND

The present invention relates to systems, methods, and products for distributed media access, including, more particularly, network-based delivery of media.

Prior art streaming architectures and methods have been employed to deliver media from various sources via network. Many of these prior art devices have, however, proven cumbersome or costly to use, bandwidth intensive, or unreliable in some network conditions.

The transmission of high quality video streams over IP networks becomes more and more attractive for providing IP based TV or video on demand services. Still, a fairly high bandwidth is required for achieving high quality streaming.

### SUMMARY

In network delivery systems of the prior art, content is typically streamed to consumers. A user may visit a web page stored on a web server. The user may select media content to “play” by clicking on a link associated with the content in a graphical user interface. In response to the content's selection, the web server sends a message to a streaming server, communicating the selected content. The streaming server streams content directly to the user's device through a dedicated one-to-one connection (or one-to-many connection, in the case of multiple viewers), which is a thick-pipe transmission.

In the prior art, streaming video and audio are transmitted to the user device using stateful streaming protocols that allow the transfer of data in real time by sending small portions of the content to a specific location in a specific order. These protocols include Real-time transfer protocol (‘RTP’), Real-time streaming protocol (‘RTSP’), and Real-time transport control protocol (RTCP), sometimes in combination with other proprietary protocols, such as, for example, RealNetworks Real Data Transport (‘RDT’) stream transport. A browser plugin, standalone player, or Flash application on the user device decodes and displays the data as it arrives, and then discards it.

The present invention relates to distributed media access, including, more particularly, network storage-based delivery of media. Aspects of the invention include enhanced distributed content delivery via a network. Other aspects may include web-based media delivery, such as, for example, media delivery via web browser. Some aspects may include hybrid cloud media broadcast. Other aspects include networked camera solutions integrated with enhanced media publishing for camera control and upload parameter modification according to detected network conditions. Further aspects include dynamically scalable broadcasting and flexible media consumption platforms. Still further aspects will be apparent from the following more particular descriptions of exemplary embodiments of the invention.

Embodiments of the invention include a protocol referred to as the HTTP Cloud-Based Streaming Protocol. The HTTP Cloud-Based Streaming Protocol is a Client/Server/NAS HTTP-based protocol that publishes a hyperlink URL used to retrieve digital media object play-lists from a database server storing the location of progressive downloaded stream real-time data transfer of the client (the sender of streaming data) and a network attached storage (the receiver of streaming data) and plays the process digital object asset through a web page embedded player containing HTML code on a receiving device, such as consumer electronic (CE) device.

The web-based hybrid cloud broadcast terminal illustrated herein provides download and execution of applications which are defined as a collection of documents comprising self-contained enhanced or interactive services. The object browser may comprise XHTML, CSS, and JavaScript including AJAX, definition includes the embedded media player in a HTML document.

Embodiments of the present invention include a hybrid terminal supporting a HTTP prototype streaming of a network-storage based server, client, and database server; that directly or indirectly receives transmission with an application to capture the AVI transmission into which adaptive encoding algorithms has been integrated.

A hybrid terminal may have the capability to be connected to two or more networks in parallel; such as, but not limited to, a receiver of standard broadcast AV transmission, an application streaming media protocol (i.e., MMS://), an application, and a capturing and/or recording device signaling digital data information.

In addition, the hybrid terminal network may be configured for connection to the Internet via broadband. Over this interface the terminal can receive application data and non linear content and supports download of media over any connection.

Aspects of the invention relate to systems, methods, and products for the processing of live or pre-recorded broadcasts and IP delivery of distributed media access including, more particularly, network storage-based delivery of media onto consumer electronic devices through the use of a HTTP protocol.

Embodiments of the invention include a hybrid terminal supporting HTTP streaming of a network-storage based server, client, and database server, that directly or indirectly receives transmission with an application to capture an AVI transmission into which adaptive encoding algorithms have been integrated.

Embodiments of the invention include a platform for signaling, transport, and presentation of enhanced and interactive applications designed for running on hybrid terminals. A hybrid terminal has the capability to be connected to two or more networks in parallel; such as, but not limited to, a receiver of standard broadcast AV transmission, an application streaming media protocol (i.e., MMS://), an application, and a capturing and/or recording device signaling digital data information. In addition, the hybrid terminal network can be connected to the internet via broadband. Over this interface the terminal can receive application data and non linear content and supports download of media over any connection.

Embodiments of the invention include a method and process for the capturing of signaling, transport, and presentation schemes of segmentation and encoding algorithms

Content may be fragmented for storage and delivery from multiple distributed nodes. Fragmentation may be implemented in a variety of ways and carried out in various sizes and formats to provide optimally conditioned fragments for improved content delivery across a wide range of projected network conditions. Some embodiments may involve generating copies of content fragments in multi-coded formats for distribution and consumption worldwide across a wide range of network conditions on a wide range of client devices. Distribution may include multi-threaded delivery from cloud file storage region points.

One general embodiment includes a system comprising one or more servers configured to deliver content over a network to a client on a client device in communication with the server(s). The content may include various media in one or more of several formats. The content may be generated from an application program, which may be executable program code running on the server or other computer in communication with the server. In some implementations, the application program may comprise an originating client on an originating client device, or may receive content from an originating client, either directly or indirectly. Alternatively, content may also be received from other nodes or retrieved from storage. One or more servers may be configured to capture the content (e.g., computer-generated output from the application program), process the captured output, and transmit the processed output to the client device. Alternatively, the server may store the processed output for later transmission to the client device. According to some aspects, a first server may capture and process the content, and a second server may transmit the processed output to the client device. In some cases, the processed output may be transmitted after being stored by either the first or second server. In specific embodiments, the first server may be an application server, and the second server may be a database server.

Some embodiments may include a multiplicity of second servers, such as a system of distributed database servers, including but not limited to servers incorporated as commercially available cloud storage.

One or more of the servers may be configured to process the captured output to achieve constant or relatively constant quality of variable bit rate output upon eventual transmission to the client. The client may be configured to receive transmitted converted output and execute, decode, and/or render graphics, video, and/or audio on the client device. The server may be further configured to process the captured output in order to provide either compressed file size or lower overall average bit rate at low latency. The data may be partitioned into variable-size chunks.

Processing may include converting sequences of frame set time blocks in multi-threaded encoding sequences in accordance with multiple formats such as Windows Media Video (‘WMV’), Flash Video (‘FLV’), 3GPP, M3U (m3u8), Moving Picture Experts Group (‘MPEG’), and the like through the use of one or more encoders. An encoder may publish video codec data of converted output in parallel.

Embodiments may include methods for enhanced distributed content network delivery. These methods may include generating media content on a recording device; generating segment files by segmenting the content on the recording device; and transmitting the segment files to an enhanced distributed content delivery server, such as a data server, or cloud based storage; and storing the segment files in networked storage. Methods may also include generating one or more index files comprising order information facilitating playback of segment files in a playback order corresponding to a native playback order of the content; and transmitting the index files to an enhanced distributed content delivery server, such as a media delivery network server. Methods may include transmitting the order information, as playlist or index files, to a client device in response to the client device initiating playback; receiving from the client device a request for each segment file in a retrieval sequence corresponding to the playback order; transmitting the stored segment files to a client device according to the retrieval sequence; and rendering, at the client device, the segment files according to the retrieval sequence.

In one embodiment, a method for enhanced distributed content network delivery includes generating dynamic media content on a source device; generating segments by segmenting the content on the source device or a coupled network device; generating one or more files comprising order information facilitating playback of segment files in a playback order corresponding to a native playback order of the content; transmitting the segment files to networked storage; storing the segment files in networked storage; transmitting the order information to a database server; and storing the order information in a database. Another method includes transmitting the order information to a client device in response to the client device initiating playback of the content; in response to receiving the order information at the client device, sending a request for each segment file in a retrieval sequence corresponding to the playback order; in response to receiving each request from the client device, transmitting the stored segment files to a client device according to the retrieval sequence; and rendering, at the client device, the segment files according to the retrieval sequence.

One aspect of the invention may include a dynamically scalable architecture for delivery of real-time video packet data sent over a communication network. A control mechanism may be embedded in the architecture to provide for the management and administration of users who are to receive the real-time video packet data.

Another aspect may include a system for improving delivery of content created at a remote device and transmitted for cloud storage and eventual transmission and consumption. General embodiments may include methods comprising processing content to facilitate, improve, or optimize enhanced distributed content delivery over networks including sub-optimal network conditions. In some embodiments, processing is carried out at the remote device. Processing may be carried out by a processing module installed or embedded on the remote device, which may be a recording device, such as, for example, a digital or analog video camera, smart phone, or media player. The processing module may be implemented as software, firmware, or hardware logic. The module may include a set of application modules that manages the recording or capturing device. The system may be configured to manage the recording device and to modify operations of the device in response to network conditions at any point in the distributed delivery system. The system may be further configured to manage the recording device and to modify operations of the device in response to commands issued remotely over the network.

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a module. Embodiments of the invention may be implemented as any viable computing device including logic and memory, or software modules including computer program instructions executed thereon, as will occur to one of ordinary skill in the art, including devices where logic is implemented as field-programmable gate arrays (‘FPGAs’), application-specific integrated circuits (‘ASICs’), and the like.

Aspects of the present invention are described below with reference to flowchart illustrations of methods, devices, and computer program products according to embodiments of the invention. Each block of the flowchart illustrations (or combinations of blocks in the flowchart illustrations) can be implemented by computer program instructions provided to a processor of a special purpose computer or other programmable data processing apparatus for execution to implement the functions specified in the flowchart blocks. These computer program instructions may also be stored in a computer readable medium, such that the instructions stored in the computer readable medium produce an article of manufacture including instructions which implement the functions specified in the flowchart blocks.

Other embodiments may include a controller for enhancing distributed content delivery. The controller may include circuits configured to facilitate enhancing distributed content delivery. The controller may include programmed logic circuit for enhancing distributed content delivery. The programmed logic circuit may be adapted to capture media content output and encode segmented media.

Other embodiments of the present invention include a design structure embodied in a machine readable storage medium for at least one of designing, manufacturing, and testing a design. The design structure may include the controller for enhanced media delivery, constituent modules or circuits thereof, or constituent modules or circuits of the apparatus. The design structure may include a netlist which describes the controller, apparatus, or constituent modules or circuits. The design structure may reside on the machine readable storage medium as a data format used for the exchange of layout data of integrated circuits.

Other embodiments of the present invention include a method for delivering dynamic media content to a client on a client device. The method includes generating a multiplicity of segments by segmenting dynamic media content, wherein each segment contains a portion of the dynamic media content, and wherein the multiplicity of segments taken together comprise a totality of information comprising the dynamic media content; sending each respective individual segment to one of a series of data server units for storage, wherein each data server unit is configured to send the respective individual segment to the client device; without regard for the multiplicity of segments, analyzing the dynamic media content to determine playback characteristics and generating a playlist according to the playback characteristics, the playlist indicating a playback order of the respective individual segments which results in rendering a reconstitution of the dynamic media content; and sending the playlist to a network server. The playlist may be configured to be natively processed by a web browser. Each data server unit comprising: data storage containing the segment; and a database server configured to deliver the respective individual segment for transmission to the client device. The method may also include the native processing directing the web browser to: initiate HTTP requests for the respective individual segments to corresponding data server units according to the playback order; download the respective individual segments from the corresponding data server units according to the playback order; and render the respective individual segments according to the playback order so as to render a reconstitution of the dynamic media content.

Other embodiments of the present invention include a method for enhanced distributed content network delivery. The method includes accepting dynamic media content from a content provider; generating a multiplicity of segments by segmenting dynamic media content, wherein each segment contains a portion of the dynamic media content, and wherein the multiplicity of segments taken together comprise a totality of information comprising the dynamic media content; generating a playlist indicating a playback order of the respective individual segments which results in rendering a reconstitution of the dynamic media content; and providing access to the content to individual client devices in exchange for an individual fee; aggregating the individual fees; and charging the content provider a multiple of the aggregated individual fees.

Other embodiments of the present invention include a method for enhanced distributed content network delivery. The method includes generating media content on a recording device; generating segment files by segmenting the content on the recording device; generating one or more index files comprising order information facilitating playback of segment files in an order corresponding to a native playback order of the content; transmitting the segment files and the index files to an enhanced distributed content delivery server; storing the segment files in networked storage; serving the segment files to a client device for playback.

Other embodiments of the present invention include a method for enhanced distributed content network delivery. The method includes generating dynamic media content on a source device; generating segments by segmenting the content on the source device; generating one or more files comprising order information facilitating playback of segment files in a playback order corresponding to a native playback order of the content; transmitting the segment files to networked storage; transmitting the order information to a database server; storing the order information in a database; transmitting the order information from the database server to a client on a client device in response to the client initiating playback of the content, the order information configured to serially generate a request for each segment in a retrieval sequence corresponding to the playback order upon being processed by the client; in response to receiving a request from the client device at the networked storage, transmitting the stored segment files to a client device according to the retrieval sequence for rendering according to the retrieval sequence.

Other embodiments of the present invention include computer program products embodied in one or more computer readable media having computer readable program code disposed thereon. These computer program products may include computer program code adapted to carry out the methods of the present invention on one or more data processing system (computer).

Other general embodiments include a system comprising one or more data processing systems. The data processing systems comprise a processor and a computer memory operatively coupled to the processor. The computer memory has disposed within it computer program instructions for execution on the processor to implement one or more of the method embodiments described above. Other embodiments include computer program products disposed on a computer readable medium comprising computer program instructions for carrying out one or more of the method embodiments described above by their execution on a computer processor.

The foregoing and other objects, features and advantages of the disclosure will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

The following figures are part of the present specification, included to demonstrate certain aspects of embodiments of the present disclosure and referenced in the detailed description herein.

FIG. 1A is a data flow diagram illustrating a use case in accordance with embodiments of the invention.

FIG. 1B is a data flow diagram illustrating a use case in accordance with embodiments of the invention.

FIG. 2A is a data flow diagram illustrating a system in accordance with particular embodiments of the invention.

FIG. 2B is a data flow diagram illustrating another system comprising an enhanced source device in accordance with particular embodiments of the invention.

FIG. 2C are data flow diagrams illustrating another system comprising a source device coupled to an enhanced network computing device in accordance with particular embodiments of the invention.

FIG. 2D is a data flow diagram illustrating another system comprising an enhanced source device configured to upload objects directly to cloud storage in accordance with particular embodiments of the invention.

FIG. 3 sets forth a block diagram of an exemplary computer used in embodiments of the present disclosure.

FIG. 4 sets forth a block diagram illustrating a method for enhanced distributed media delivery in accordance with one embodiment of the invention.

FIG. 5 sets forth a block diagram illustrating a method for enhanced distributed media delivery in accordance with one embodiment of the invention.

FIGS. 6A and 6B set forth a block diagram illustrating a method for enhanced distributed media delivery in accordance with one embodiment of the invention.

FIG. 7 sets forth a block diagram illustrating a method for enhanced distributed media delivery in accordance with one embodiment of the invention.

FIG. 8 sets forth a block diagram illustrating a method for enhanced distributed media delivery in accordance with one embodiment of the invention.

FIG. 9 sets forth a block diagram illustrating a method for enhanced distributed media delivery in accordance with one embodiment of the invention.

### DETAILED DESCRIPTION

The principles of the invention are explained by describing in detail, specific example embodiments of devices, products, and methods for distributed media delivery, including, more particularly, network-based delivery of media. Those skilled in the art will understand, however, that the invention may be embodied as many other devices, products, and methods. For example, various aspects of the methods and devices may be applied to other content, advertising, or data. Many modifications and variations will be apparent to those of ordinary skill in the art. Embodiments were chosen and described in order to best explain the principles of the invention and the practical application, and to enable others of ordinary skill in the art to understand the invention for various embodiments with various modifications as are suited to the particular use contemplated. The scope of the invention is not intended to be limited by the details of exemplary embodiments described herein. The scope of the invention should be determined through study of the appended claims.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, implement the functions/acts specified in the flowchart and/or block diagram block(s).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block(s).

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block(s).

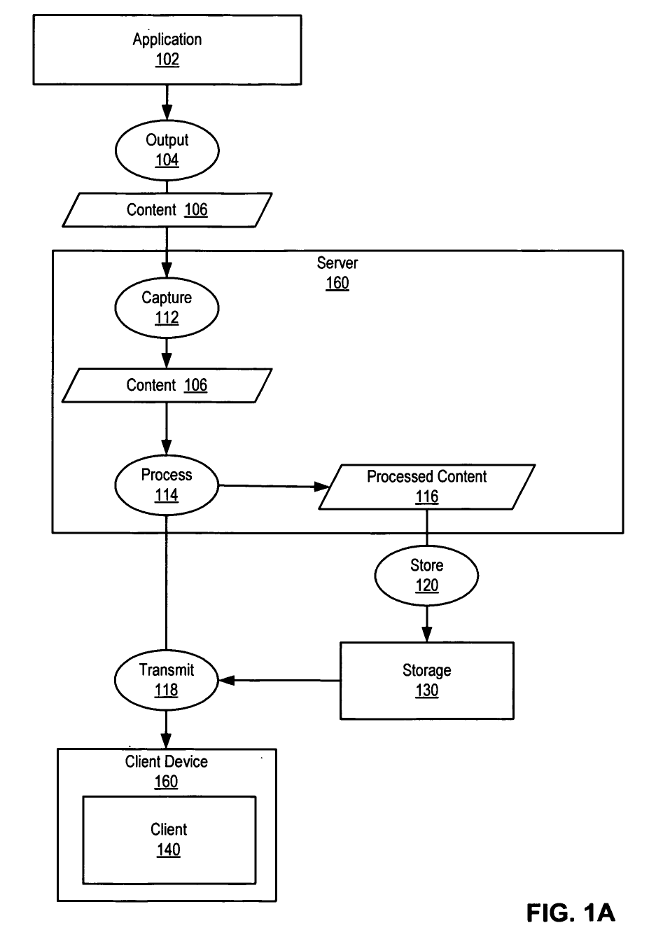

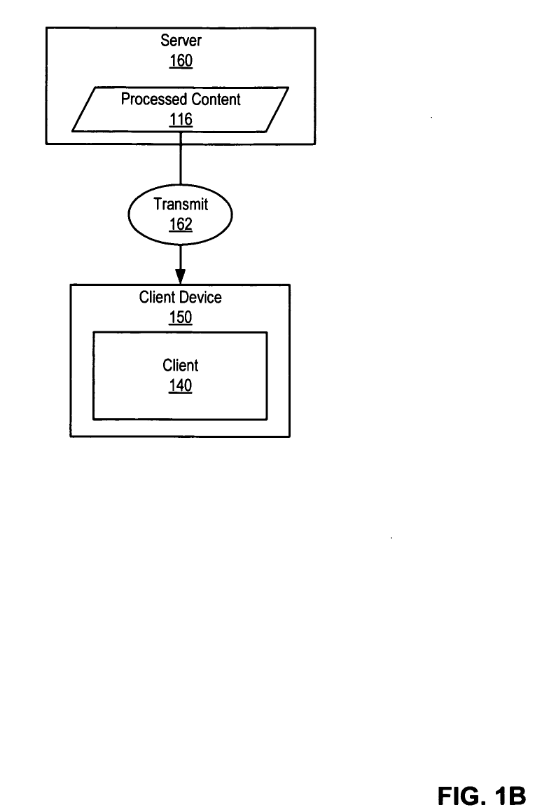

FIG. 1A is a data flow diagram illustrating a use case in accordance with embodiments of the invention. Referring to FIG. 1A, content 106 is output (104) from an application program 102. The content 106 may include various media (e.g., songs, video, graphics, etc.) in one or more of several formats, such as, for example, formats according to the standards for Moving Picture Experts Group (‘MPEG’), Audio Video Interleave (‘AVI’), QuickTime (.mov), Windows Media Video (‘WMV’), DV, Flash Video (‘FLV’), Small Web Format (‘SWF’), Legacy RealMedia (.rm), raw file formats, and so on. The application program 102 may output the content of a media file as an output stream. The application program 102 may be executable program code running on a computer, such as, for example, a client device or server device. A server program 110 running on a server device receives the content 106. The application program 102 may be running on the same device as the server 110, or may be coupled to the server device directly or through a network.

In some implementations, the application program may comprise an originating client on an originating client device, or may receive content from an originating client, either directly or indirectly. Alternatively, content 106 may also be received from other nodes or retrieved from storage (not shown). The content may be streamed or may be in a streaming compatible format. In content streaming, a program playing the streaming file discards the data as it is rendered. The server 110 captures (112) content 106, processes (114) the captured content 106, and transmits (118) the processed content 116 to a client 140 on a client device 150. The client device 150 may be any device capable of consuming media, such as, for example, a computer, a smart phone, a digital media player, an automobile, or any other device having digital audio or video rendering capabilities.

Alternatively, the server 110 may store (120) the processed output 116 in storage 130 for later transmission to the client device 150. In specific embodiments, a first server may capture and process the content, and a second server may transmit the processed output to the client device. In some cases, the processed output may be transmitted after being stored by either the first or second server.

FIG. 1B is a data flow diagram illustrating a use case in accordance with embodiments of the invention. Referring to FIG. 1B, server 160 transmits (162) processed content 116 to client 140. Server 160 may be the same server as server 110, or a separate server. Content 116 may be transmitted directly following processing at server 160 or following transmission from another server, such as, for example server 110; or after being retrieved from storage 130. Client 140 consumes 164 content 116 by rendering content on client device 150.

Transmitting the content according to some embodiments of the invention provides enhanced distributed content delivery, as discussed in further detail below. Processing is carried out to facilitate enhanced distributed content delivery, by providing processed content 116 which is more readily transmitted in the manner disclosed. Transmitting (162) of server 160 to client 140 allows delivery of high definition media across PC, android, television, and PlayStation3 platforms and the like without downloading third party plug-ins (e.g., FLASH player) or other software. All software for receiving and rendering media on the client device is contained in the browser environment.

Processing may include fragmenting media content for storage and delivery from multiple distributed nodes. Fragmentation may be implemented in a variety of ways and carried out in various sizes and formats to provide optimally conditioned fragments for improved content delivery across a wide range of projected network conditions. Some embodiments may involve generating copies of content fragments in multi-codec formats for distribution and consumption worldwide across a wide range of network conditions. Distribution may include multi-threaded delivery from cloud file storage region points.

Embodiments of the invention include a protocol referred to as the HTTP Cloud-Based Streaming Protocol. The HTTP Cloud-Based Streaming Protocol is a Client/Server/NAS HTTP-based protocol that publishes a hyperlink URL used to retrieve digital media object play-lists from a database server storing the location of progressive downloaded stream real-time data transfer of the client (the sender of streaming data) and a network attached storage (the receiver of streaming data) and plays the process digital object asset through a web page embedded player containing HTML code on a receiving device, such as consumer electronic (CE) device. Details regarding an example protocol illustrating embodiments of the present invention are described below.

### Transport

The Cloud-Base streaming HTTP protocol uses HTTP as the transport layer. The application-level protocol is used for distributed, collaborative, hypermedia information systems, and may use a reliable transport such a TCP/IP. Hyperlinks identify object browser parameters of requested digital data/file in container frames.

### File Transfer

The protocol may use a token access authentication functionality of the HTTP layer and support HTTP accessible authentication to network attached storage via standard Internet APIs and communication protocols including, but not limited to, HTTP, FTP, XML, SOAP, and REST. Schemes are implemented by client application use of headers to specify the directory access and location to published stored digital media files.

File transfer is based on Internet Protocol (IP) to handle addressing. File transfer is accomplished by publishing dynamic playlist packets that are routed across multiple nodes and even across multiple networks with multiple standards.

File transfer is further implemented using a transmission control protocol (TCP). The protocol converts broadcast stream digital data (e.g., stream, file) into binary text data packets at the source, then reassembles them back at the destination. TCP port 80 or 8081 is most commonly used for HTTP proxy servers and accepts only forward HTTP traffic generated from port 80 or 8081, and may be employed by the protocol. Other ports may also be used.

### Broadcast

In some embodiments, a client application is written in ASP.NET and is responsible for the capturing of recorded and pre-recorded digital media data/files. It contains processing components to create and encode broadcast streaming jobs to enable live or on-demand display from the browser to play from an embedded HTML player onto native devices. Broadcast stream jobs are created by the client application installed on the desktop client or server side client application.

### Record

In some embodiments, the client application uses a content acquisition module, such as, for example, Video Grabber SDK, to record video and audio from connected video input sources. Video input sources include but are not limited to HD webcams, camcorders through firewire or USB, all standard USB webcams and DV camcorders through firewire, USB analog composite/SVideo capture devices, PCI analog Composite/Svideo and digital capture cards, Blackmagic Decklink, IP cameras in MPEG or JPEG Mode, RTSP IP cameras in H264/MPEG4+audio, and capture devices including hardware encoders.

Depending on the RecordingMethod, it is possible to record in AVI format to an AVI file, “as is” or through the video and/or audio compressors installed on the current platform; record in ASF format to a stream-able ASF file, with optional network streaming, directly to the network, or to a Windows Media Server; send the audio/video stream to a DV device (an option also known as “Send to DV” or “Print to DV”); stream directly from the network Windows Media server. If AudioRecording is disabled, only the video source (VideoDevice, chosen in the VideoDevices list) will record to the AVI or ASF file. If AudioRecording is enabled, the current VideoDevice and the current AudioDevice (chosen in the AudioDevices list) will be captured.

### Capture

Initially, the process of digitization of a broadcast stream job is created by the client application installed on a desktop client or server side client application. As a broadcast stream job begins, the client application renders a progressive visual display and initiates a command to FFMPEG to capture the digital media data/files and decode to an intermediate uncompressed AVI format or other format such as PCM for audio or YUV for video. The digital data/file is sent through progressive download to a physical drive or network attached storage.

The recording is started by invoking StartRecording” and is stopped by invoking StopRecording. The RecordingTimer property enables start, stop or restart of recording periodically. Other functions:
RecordingTimer=rt_Disabled: normal start/stop
RecordingTimer=rt_RecordToNewFile: a new recording file is generated each RecordingTimerInterval seconds
RecordingTimer=rt_StopRecording: the recording will stop after RecordingTimerInterval seconds
RecordingTimer=rt_StartRecording: the recording starts in preview mode only; the real recording will begin after RecordingTimerInterval seconds

After the recording begins (triggered by invoking StartRecording), invoking RecordToNewFileNow (NewFileName, ResetStreamTime) causes a new video clip to be created. New file name to be used may be specified as a parameter, or an empty string may be passed to allow the new file name to be generated automatically, according to the AutoFileName setting. Passing “true” as ResetStreamTime parameter resets the stream time and frame count. Passing “false” as ResetStreamTime parameter lets the stream time and frame count increase.

In one embodiment, segmentation of the AVI file takes the form of a single chunk in a RIFF formatted file, which is then subdivided into two mandatory “chunks” and one optional “chunk”. By way of the RIFF format, the audio-visual data contained in the “AVI” chunk is segmented by using FFMPEG. The segmenter may employ libavformat to compile. The process of segmentation creates both single and variable outputs for progressive download digital file/data. Optimization may be accomplished through the use of chunk-ed technology in frame parameters to segment time interval chunks evenly. The protocol uses a command to split recorded digital data captured and encoded by FFMPEG into variable second intervals. To ensure that broadcast stream data files are correctly downloaded, two mime types are applied to digital media data/file stream packets.

Recorded video captured in AVI format is stored on the desktop hardware. FFMPEG encodes the AVI raw data to 4 formats—(.ts, 3gp, wmv, flv) and segment streams are published to the network attached storage via FTP; and from there are progressive downloaded onto network attached storage.

| | | |
|---|---|---|
| [symbol] pl.asp | 10/5/2011 9:27 AM | Active Server Page |
| [symbol] playlist.asx | 10/5/2011 9:27 AM | VLC media file (.asx) |
| [symbol] playlist.m3u8 | 10/5/2011 9:27 AM | VLC media file (.m . . . |
| [symbol] playlist3gp.txt | 10/5/2011 9:27 AM | OpenOffice.org1 . . . |
| [symbol] playlistflv.asx | 10/5/2011 9:27 AM | VLC media file (.asx) |
| [symbol] plflv.asp | 10/5/2011 9:27 AM | Active Server Page |
| [symbol] plwmv.asp | 10/5/2011 9:27 AM | Active Server Page |

The format of the segmenter command is segmenter <input MPEG-TS file><segment duration in seconds><output MPEG-TS file prefix><output m3u8 index file><http prefix>

The transfer of processed digital file/data segmented frame data/files and encoding profiles are downloaded via use of copy, FTP, SCP.
temp_dir—location the script will put segments before they are transferred to their final destination
segment_prefix—prefix added to each stream segment
index_prefix—prefix added to the index
log_type—logging type to use. Options are: STDOUT, FILE
log_file—If using FILE logging type, destination of the log file
log_level—level of logging to output. Options are: DEBUG, INFO, WARN, ERROR
input_location—location the origin video is coming from. This can be a file, a pipe, a device or any other media that is consumable by FFMpeg or the given source consumer. See the source_command option as well.
segment_length—video segment length in seconds
url_prefix—URL where the stream (ts) files will end up
index_segment_count—number of segments to keep in the index
source_command—command used to push video to encoders
segmenter_binary—location of the segmenter
encoding_profile—Specifies what encoding profile to use. It can be either a single entry, ‘ep_{—}128k’, or an array, [‘ep_{—}128k’, ‘ep_{—}386k’, ‘ep_{—}512k’], for multi-bitrate outputs.
transfer_profile—transfer profile to use after each segment is produced

Encoding profiles are given a name and have two options following that name:
ffmpeg_command—command to use for this encoding profile
bandwidth—amount of bandwidth required to transfer this encoding

Transfer profiles are given a name in the same way encoding profiles are and have various options following their name

### Encode

The AVI file may carry audio/visual data inside the chunks in virtually any compression scheme and the command line encoding to target device native player formats are defined by the client application to encoded to target multiple device codec including but not limited to (.ts, fly, 3gp, wms). Some recording methods include

record in FLV format by using third-party codecs,

record in MP4 format by using third-party codecs,

record in .m3u8 format by using third-party codecs,

record in 3GP format by using the Google's WebM/VP8 codecs

| | | |
|---|---|---|
| [symbol] s00000153_0003.avi | 10/5/2011 9:30 AM | VLC media file (.avi) |
| [symbol] s00000153_0003.flv | 10/5/2011 9:31 AM | VLC media file (.flv) |
| [symbol] s00000153_0003.ts | 10/5/2011 9:31 AM | VLC media file (.ts) |
| [symbol] s00000153_0004.avi | 10/5/2011 9:31 AM | VLC media file (.avi) |
| [symbol] s00000153_0004.flv | 10/5/2011 9:32 AM | VLC media file (.flv) |
| [symbol] s00000153_0004.ts | 10/5/2011 9:32 AM | VLC media file (.ts) |
| [symbol] s00000153_0005.avi | 10/5/2011 9:32 AM | VLC media file (.avi) |

The process of digitization converts digital media data/file into a single binary code. The binary specifics the parameters of the data container frames of the object browser and every frames has specifications on pixels and then every pixels is defined within the frame by location points x, y, and RGBA.

The first sub-chunk is identified by the “hdrl” tag. This sub-chunk is the file header and contains metadata about the video, such as its width, height and frame rate. The second sub-chunk is identified by the “movi” tag. This chunk contains the actual audio/visual data that make up the AVI movie. The third optional sub-chunk is identified by the “idx1” tag which indexes the offsets of the data chunks within the file. At this point two sets of files are created: one that represents the file chunks digital data/file stream and another to represent stream manifest files.

.m3u8 application/x-mpegURL
.ts video/MP2T

HTTP may be supported with the addition that the range header may be supported in seek operations. The terminal may only buffer data equivalent to approximately x second of normal play in advance of the current play position unless the download rate is consistently lower than the consumption rate.

Where uni-cast streaming of non transport stream based AVI video format and using HTTP is supported the terminal may support the AVI over TCP transport method.

```
  End If
  ‘End If
  ‘End Using
  ‘Catch ex As Exception
  ‘ MessageBox.Show(“Error: ” & Exception,
  “Error”, MessageBoxButtons.OK, MessageBoxIcon.Error)
  ‘End Try
End Sub
Private Sub FileUploadbyStatus(ByVal FileName As String,
ByVal JobTitle As String, ByVal FileNameWithPath As Stri [symbol]
  ‘Try
  ‘ [symbol]   Open File to Upload
  ‘Using Dialog As New OpenFileDialog
  ‘Dialog.Title - “Select one file to upload:”
  ‘Dialog.Multiselect = False
  ‘If Dialog.ShowDialog - Windows.Forms.DialogResult.OK Then [symbol]
  in FilePath As String - JobTitle & FileName [symbol]
  Path.Combine(StreamStoreFolder, Path.GetFileName(Dialog.FileNa [symbol]
  ‘Begin connect to WebService
  Using Service As New localhost.WebService
    ‘Create New Remote File
    Try
      Service.WriteFile(FilePath, Nothing, False, [symbol]  xception)
    Catch Ex As Exception
      MsgBox(Ex.Message)
    End Try
    ‘Open Local File [symbol]
indicates data missing or illegible when filed
```

Plain text is the contents of an ordinary sequential file readable as textual material without much processing. The encoding has traditionally been either ASCII, one of its many derivatives such as ISO/IEC 646 etc., or sometimes EBCDIC. Unicode-based encodings such as UTF-8 and UTF-16 are gradually replacing the older ASCII derivatives limited to 7 or 8 bit codes.

PLS is a computer file format that stores multimedia playlists. It is a more expressive format than basic M3U, as it can store (cache) information on the song title and length (this is supported in extended M3U only). With PLS version 2, playlists also include a PLS version declaration. PLS play files without any extra codecs, however the requirements of the appropriate MIME or file extension associations.

The format is essentially that of an INI file:

### Header

[playlist]: This tag indicates that it is a Playlist File

### Track Entry

Assuming track entry #X

FileX: Variable defining location of stream.

TitleX: Defines track title.

LengthX: Length in seconds of track. Value of −1 indicates indefinite.

### Footer

NumberOfEntries: This variable indicates the number of tracks
Version: Playlist version. Currently only a value of 2 is valid.

### Playlist File

The HTTP Web server creates a playlist file that contains a single entry pointing to a stream on the internet. The file is saved with the “M3U” or ‘m3u” filename extension, and Playlist M3U is a computer file format that stores multimedia playlists. Text editors encode it in the Windows-1252 format in order to be understood by media players. The “m3u” files properly use the Latin-1 charset. The unicode version of “m3u” is “m3u8”, which uses UTF-8 unicode characters.

Specifications can Include One of the Following

an absolute local pathname

a local pathname relative to the M3U file location

a URL

The M3U file can also include comments, prefaced by the “#” character. In extended M3U, “#” also introduces extended M3U directives. AN M3U file is a plain text file that specifies the location of one or more media files that the media player should play.

#EXTM3U—header—must be first line of file
#EXTINF—extra info—length (seconds), title

A Dynamic Active Server Page is a web page that “executes” in a server-side execution environment in Microsoft Internet Information Server (IIS) 3.0, or higher, and that uses ActiveX scripting, normally VBScript or JavaScript code. When a browser requests an ASP page, the Web server generates a page with HTML code and transmits it back to the browser. An Active Server Page can combine HTML with scripts to create dynamic, interactive, and appealing Web pages.

A scripting code runs on the server and produces HTML output, which is then sent to the browser for display. When a browser requests an ASP file from the web-server, the ASP interpreter reads through the ASP file, executes any of the ASP commands contained within and sends the resulting HTML to the browser. playlist generated in ASP is dynamic.

Prior to being able to run ASP pages, a ASP-enabled Web server installed with Window 2003/2008 on its hardware system, and installation of Internet Information Server (IIS) is required. The foundation of ASP is Microsoft's Internet Information Server. IIS utilizes scripting engines for VBScript and other languages. VBScript is the default language of ASP, however you can use other scripting languages such as JavaScript or PerlScript.

In order to run an ASP page, a directory is made accessible to the Web server. This is because the server must first interpret the ASP file so that it can run properly.

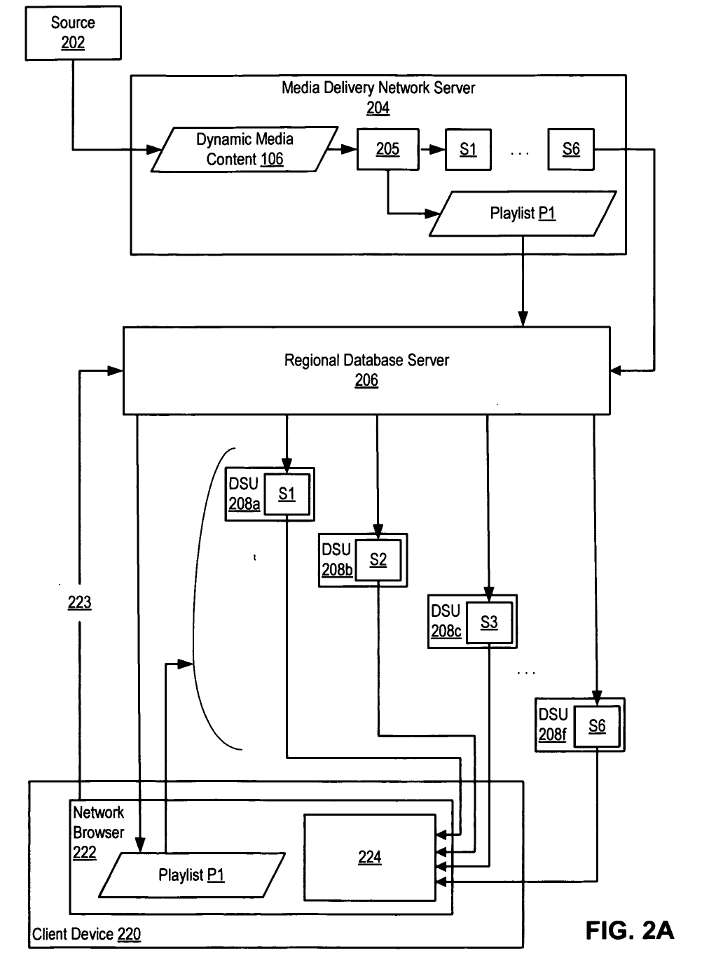

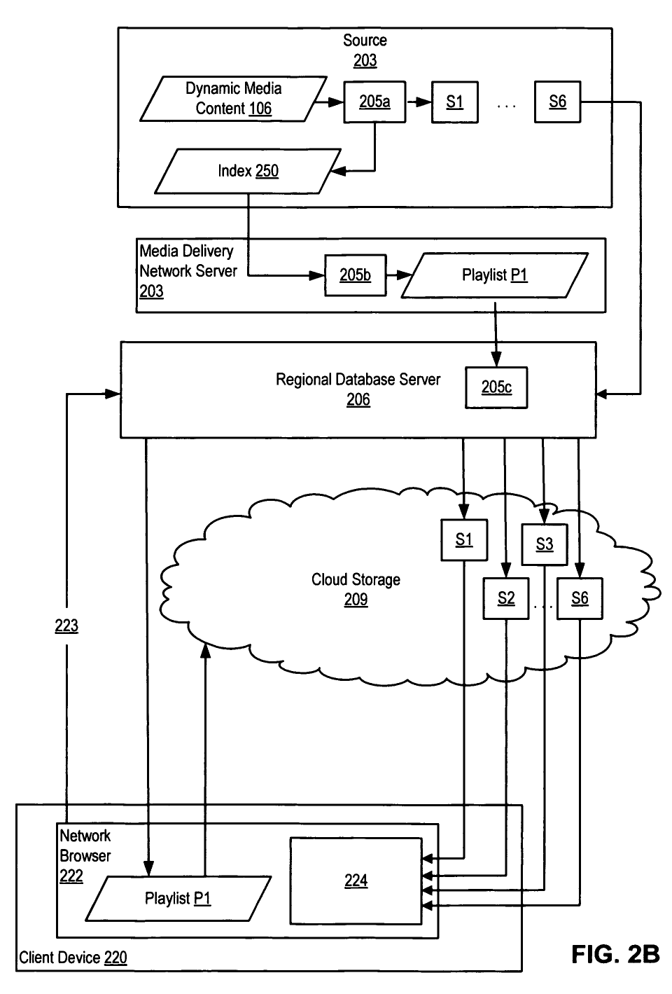

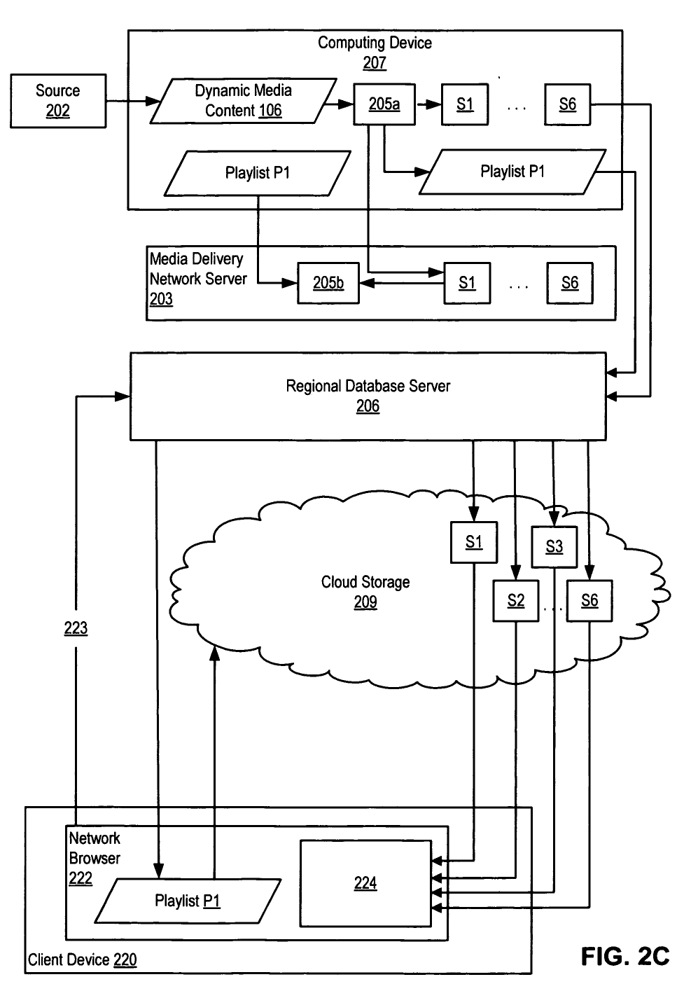

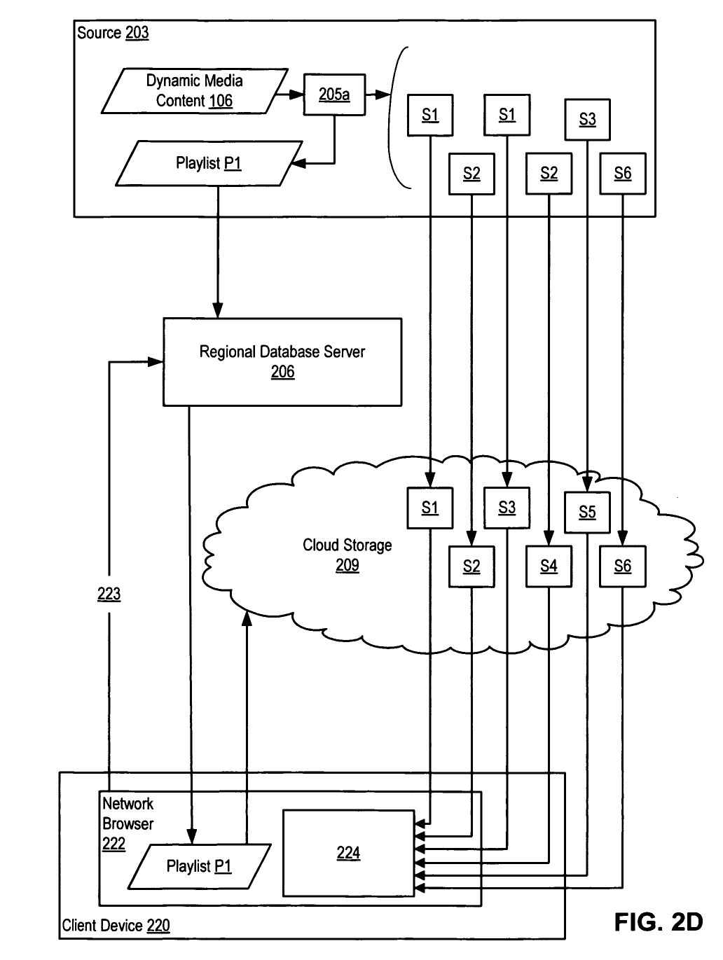

Enhanced distributed content delivery as described herein allows continual rendering of content in a progressive delivery manner, and use of distributed storage decreases bandwidth consumption, as discussed further below with regard to FIG. 2A. Data may be published in cloud storage; users may retrieve a playlist to redirect a browser to specific cloud storage and retrieve a fresh copy of that segment point in the time frame playlist, so bandwidth is not affected and content quality is maximized. Additionally, lowered bandwith requirements allow source devices to store content directly to the cloud for consumption, increasing flexibility and decreasing costs. The use of data server units in the place of streaming media servers also allows for the implementation of a directly scalable transmission model.

FIG. 2A is a data flow diagram illustrating a system in accordance with particular embodiments of the invention. The system of FIG. 2A includes a source 202 providing dynamic media content as output. Dynamic media content is any content which features unpredictable changes in sound or video output on a momentary basis, including, but not limited to video, audio, dynamic computer graphics (e.g., output from video games or virtual reality), a streaming media file, inherently streaming media (e.g., component, composite, DVI, HDMI, etc.), and so on. The source may be any physical player device (e.g., commercial disk players capable of playing discs encoded in BlueRay, DVD, CD or other formats for display on a connected screen), software player, camera, camcorder, broadcast television system, graphics application, and/or graphics processing hardware, software, or firmware. The source 202 is coupled (directly or through a network) to one or more media delivery network servers 204 executing processing module(s) 205. The media delivery network servers 204 may be application servers running on one or more dedicated physical server computers and/or virtualized servers. The application servers could be any open-source or proprietary application server, such as, for example, Apache based server bundles, servers based on Java Platform, Enterprise Edition (‘Java EE’) operability, Microsoft .NET Framework, or any other application server platform as would occur to those of skill in the art.

Processing module 205 may capture and perform processing on dynamic media content from source 202 to condition the content for distributed delivery. Processing module 205 may process content to facilitate enhanced distributed content delivery over networks including sub-optimal network conditions. Capture may be performed using a content acquisition module, such as, for example, the TVideoGrabber Video software development kit (‘SDK’). Processing module may also include integrated custom features and programming to enable future additional features, such as text and graphic overlays, video processing, mixer, and the like. The content acquisition module may capture video and audio from virtually any source, such as, for example, DV camcorders, USB webcams, IP Cameras, PCI composite and digital capture cards, USB capture devices, IEEE1394 (‘Firewire’) cameras, HD cameras, TV cards, Blackmagic Decklink, audio/video codecs including MPEG, DivX, OpenDivX, XVid, and so on. Processing may include fragmenting media content for storage and delivery from multiple distributed nodes. Fragmentation may be carried out to provide optimally conditioned fragments for improved content delivery across a wide range of projected network conditions. In one embodiment, the dynamic media content is segmented into a multiplicity of segments with each segment containing a portion of the dynamic media content. A progressive segmenter module operates to segment video streams into multi-second chunks (e.g., 1, 2, 10, 20, 30, 60, 120 seconds, variable durations under 60 or 120 seconds, or any other duration); the chunks are published using a standard MPEG-2 transport stream file format (.ts). In one implementation, video and audio source output is encoded or transcoded to an MPEG-2 transport stream container, and then segmented by a software or hardware segmenter to create a segment file. The segmenter module may create an index file providing the order in which the segments are to be played back. Processing module 205 may generate a playlist using the index file. Processing module 205 may assign a playlist signature to the segments and tag the segments according to frame.

Processing may include generating copies of segments in multi-codec formats by converting sequences of content into multiple formats (hereinafter “multi-threading”), before or after segmentation through the use of one or more encoders or transcoders, such as, for example, the ffmpeg command line program for transcoding multimedia files. Example formats include Windows Media Video (‘WMV’), Flash Video (‘FLV’), 3GPP, M3U (m3u8), Moving Picture Experts Group (‘MPEG’), and the like. Each copy may be formatted to play natively in a particular browser, on a particular device or class of devices, and so on, such as, for example, on an iPhone, iPad, or iPod from Apple, Inc., PlayStation3 and Flash-based platforms; Windows Media Desktop and Mobile and Silverlight; Nokia and any 3GP Player Java Phone; SamsungTV App platform; desktop; HTC; Android and Android Player App, or any other combination of device and browser. An encoder may publish video codec data of converted output in parallel.

The media delivery network servers 204 are coupled to one or more regional database servers 206 running on one or more dedicated physical server computers and/or virtualized servers. The media delivery network servers 204 may transmit segment files and playlist files to the regional database servers 206.

The regional database server 206 may be any database server, such as, for example, Oracle, IBM DB2, IBM Informix, Microsoft SQL Server, and the like, and may run a database management system (e.g., MySQL, MS SQL). The regional database server 206 may also include a web server. In one implementation, the regional database server 206 comprises a web server including extension modules for added functionalities, with possible web servers including, for example, Internet Information Services (‘IIS’) by Microsoft, Apache HTTP Server, and so on. In some embodiments, regional database server 206 may comprise front end functionality for administration and user functionality, a bit rate controller, a database module comprising a playlist signature generator, and a publisher module comprising a frame packet service API. The bitrate manager strings together encoded .ts files and tags by frame sequence. The publisher generates a playlist from frames and publishes to cloud storage; the publisher also tags the playlist by region of cloud storage and segment.

In operation, the regional database server 206 may store the segment files (S1-S6) received from any of the media delivery network servers 204 in a series of data server units 208a-208f, wherein each data server unit 208a-208f includes data storage 212a-212f containing the segment S1-S6 and a database server 210a-210f configured to deliver the respective individual segment S1-S6 for transmission to a client device 220. Alternatively, media delivery network servers 204 may transmit individual segments directly to their respective data server unit 208a-208f (not shown).

The client device 220 is connected to the regional database server 206 and data server units 208a-208f through networks. The client device 220 may be a smart phone, touchscreen computer, laptop computer, desktop computer, digital media player, or network enabled television, set-top box, media player, automobile, or the like. The client device 220 has a network browser 222, which may be a web-enabled browser, such as for example, Microsoft Internet Explorer, Mozilla Firefox, Google Chrome, Safari from Apple, Inc., Opera from Opera Software, and so on. Networks may include, alone or in combination, one or more local area networks (‘LANs’), wide area networks (‘WANs’), wired or cellular telephone networks, intranets, or the Internet.

The regional database server 206 maintains an active live and on-demand playlist database of published frame segments storage location. Where the data server units are implemented as cloud storage, the regional database server 206 maintains the playlist database using a PUT method containing the API-access cloud file storage container and location.

In response to requests 223 from browser 222, regional database server 206 may send the playlists to the web browser and may serve files of the segments. The browser 222 sends a request 223 for content (e.g., an HTTP request message with a GET request directed at a URI of the playlist file) to the regional database server 206 and receives a playlist P1 for use in viewing content on the client device 220. For example, the published HTTP hyperlink may POST the corresponding playlist database file to redirect viewer to the location of the Frame segment streams. Playlists may be generated in plaintext binary codes.

In one embodiment, Progressive HTTP Streams are created and pushed to devices through the hyperlink and a device-ready codec custom browser player begins to stream the file. This method utilizes TCP/IP Range Requests to allow the user to jump to any portion of the video. The player makes a range request of the file to download that portion, enabling play of live or on-demand dynamic media content on every device-native player with an available codec.

The playlist indicates a playback order of the respective individual segments which results in rendering a reconstitution of the dynamic media content 224. The browser is directed by the playlist to redirect to links directed at segment files S1-S6 from data server units 208a-208f in sequence. This transmission of segments from the data server units may be a many-to-one transmission model with respect to the client. The playlist instructs the browser to load and render the segment files from the data server units in order, so that the content is recreated in the browser 222.

In some embodiments, the playlist is configured to be natively processed by the web browser, whereby the native processing directs the web browser to initiate HTTP requests for the respective individual segments to corresponding data server units according to the playback order. The browser downloads the respective individual segments from the corresponding data server units according to the playback order and renders the respective individual segments according to the playback order so as to render a reconstitution of the dynamic media content. In other embodiments, segments are transmitted using User Datagram Protocol (‘UDP’) or through Progressive Download HTTP delivery, where the web page is embedded with a segment file using special HTML code.

Embodiments of the invention could be implemented as any viable computing device including logic and memory, or software modules including computer program instructions executed thereon, as will occur to one of ordinary skill in the art, including devices where logic is implemented as field-programmable gate arrays (‘FPGAs’), application-specific integrated circuits (‘ASICs’), and the like.

FIG. 2B is a data flow diagram illustrating another system comprising an enhanced source device in accordance with particular embodiments of the invention. The system of FIG. 2B is similar to the system of FIG. 2A, and includes a source 203 coupled (directly or through a network) to one or more media delivery network servers 204. The source 203 contains processing module 205a, which may be incorporated as an embedded processing platform, and media delivery network server 204 executes processing module(s) 205b.

Processing may be carried out as described above with reference to FIG. 2A, and may include fragmenting the content. Processing module 205a may include a capture segmenter, an encoder, and so on. The fragmented (and possibly encoded) content, e.g., in the form of segments, such as, for example, .ts files, may then be transmitted for distributed storage and delivery according to embodiments described above. The segment files are relatively small and may be easily transmitted piecemeal, thus increasing content stability while decreasing bandwidth requirements. For example, High Definition video bandwidth requirements may be less than 0.5 Mbit/s, 0.25, Mbit/s, or even lower.

Source 203, through the use of processing module 205a, through other modules, through natively available networking capabilities, or a combination of any or all of these, may transmit encoded fragmented content to regional database servers 206 via network. This transmission may be initiated automatically, upon user command, or in response to a communication received from media delivery network servers 204, regional database servers 206, or other remote device. For example, the embedded processing platform may be configured to transmit encoded fragmented content according to a schedule, upon detecting a network connection, upon detecting new content, and so on. In some implementations, the segment files may be transmitted to regional database servers 206 in a striped manner to increase throughput.

The regional database servers 206 may also be configured for additional functionality such as encoding, front end functionality for administration and user interface, a bit rate controller, a database module comprising a playlist signature generator, a publisher module comprising a frame packet service API, and the like. Alternatively, the embedded processing platform may be configured for some or all of this additional functionality.

Processing module 205a may include modules adapted to capture and perform processing on content from source 203 to condition the content for distributed delivery, such as a fragmenting (e.g., segmenting) module for fragmenting media content for storage and delivery from multiple distributed nodes, as performed by processing module 205 of media delivery network server 204 in FIG. 2A. For example, processing module 205a may include an encoding module adapted to encode or transcode video and audio source output to an MPEG-2 transport stream container at source 203. After encoding or transcoding, the container is segmented by a software or hardware segmenter module to create a segment file at source 203.

Processing module 205a may assign a playlist signature to the segments and tag the segments according to frame. In one implementation, the segmenter module may create an index file 250 providing the order in which the segments are to be played back in accordance with information generated from the segmentation process. In other implementations, a playlist generator module may generate playlists without regard for information generated from the segmentation process. For example, the playlist generator module may carry out playlist generation by analyzing the dynamic media content to determine playback characteristics and generating the playlist according to the playback characteristics, through the use of a playlist template, and so on. In some embodiments, the playlist generator module may generate the playlist prior to generating the multiplicity of segments. In such examples, the playlist may be transmitted to the media delivery network server 204 prior to completion of segmentation.

As one example, for a live stream, a template for continuing the live stream for a predefined duration may be used (e.g., 30 minute, 1 hour, 24 hours). For the specific template, a predetermined number of segments may be allotted to the playlist, depending on segment length. For example, a 24-hour playlist may contain 1440 segments.

In some embodiments, an index file may be generated and transmitted to media delivery network server 204 in the place of a playlist. The processing module 205b on media delivery network server 204 may then generate a playlist from the index file and store the playlist file. After processing, the media delivery network servers 204 transmit segment files to the regional database servers 206. In alternative embodiments, media delivery network servers 204 transmit playlist (or index) files to regional database servers 206 and transmit the segment files to a series of data server units, implemented in FIG. 2B as cloud storage 209. Cloud storage 209 is a group of shared storage resources in various locations.

Processing module 205c at regional database servers 206 may perform further processing, such as multi-threading, as described in detail above. Processing module 205c may also carry out operations to mirror content at other locations. Alternatively, processing module 205b may be adapted for multi-threading prior to transmission of segments to regional database servers 206, or directly to cloud storage 209. The regional database server 206 stores the segment files (S1-S6) received from any of the media delivery network servers 204 in cloud storage 209.

FIG. 2C are data flow diagrams illustrating another system comprising a source device coupled to an enhanced network computing device in accordance with particular embodiments of the invention. In the system of FIG. 2C, the source device 202 is coupled to an enhanced network computing device 207 comprising processing module 205a. Enhanced network computing device 207 may be any device which couples a source device to a computer network, such as, for example, a desktop, a laptop, a smartphone, a proprietary network connection device, or any other device as will occur to those of skill in the art. Enhanced network computing device 207 comprises hardware or software modules (including processing module 205a, as described in detail with reference to FIG. 2B) for fragmenting (e.g., segmenting) dynamic media content accepted from the source 202, connecting with media delivery network server 204 over a network, and transmitting segments, playlists, and other information to the media delivery network server 204 and/or directly to one of regional database servers 206 (FIG. 2C). Additional processing such as multi-threading may be performed by media delivery network server 204 and/or regional database server 206.

FIG. 2D is a data flow diagram illustrating another system comprising an enhanced source device configured to upload objects directly to cloud storage in accordance with particular embodiments of the invention. Source 202 is coupled (directly or through a network) to regional database servers 206 and a series of data server units, implemented as cloud storage 209. The source 203 contains processing module 205a, as above.

In some embodiments, after segments are stored, an application server (not shown) may perform post-processing, such as multi-threading, as described in detail above. Alternatively, processing module 205a may be adapted for generating copies of segments in multi-codec formats before transmission to cloud storage 209.

In operation, segments S1-S6 are transmitted directly to cloud storage 209 from source 203; and then directly from cloud storage 209 to network browser 222 (in response to HTTP requests). Direct transmission of the segments from the source (or connected network device) to the distributed storage, in the form of data server units, or cloud storage, is very network-efficient. Further, direct transmission of segments from the distributed storage, in the form of data server units, or cloud storage, to the client allows for much more efficient and cost-effective delivery of content to the client. This distributed transmission is less demanding in terms of network requirements than traditional dedicated, one-to-one connection (thick-pipe) media streaming. In addition, use of direct transmission from cloud storage enables a dynamically scalable transmission platform, described below.

Embodiments of the presently disclosed invention are implemented to some extent as software modules installed and running on one or more data processing systems (‘computers’), such as servers, workstations, tablet computers, PCs, personal digital assistants (‘PDAs’), smart phones, digital media players, and so on. Each of source device 202, 203, media delivery network servers 204, regional database servers 206, data server units 208a-f, cloud storage 209, or computer client device 210 may be implemented as a computer.

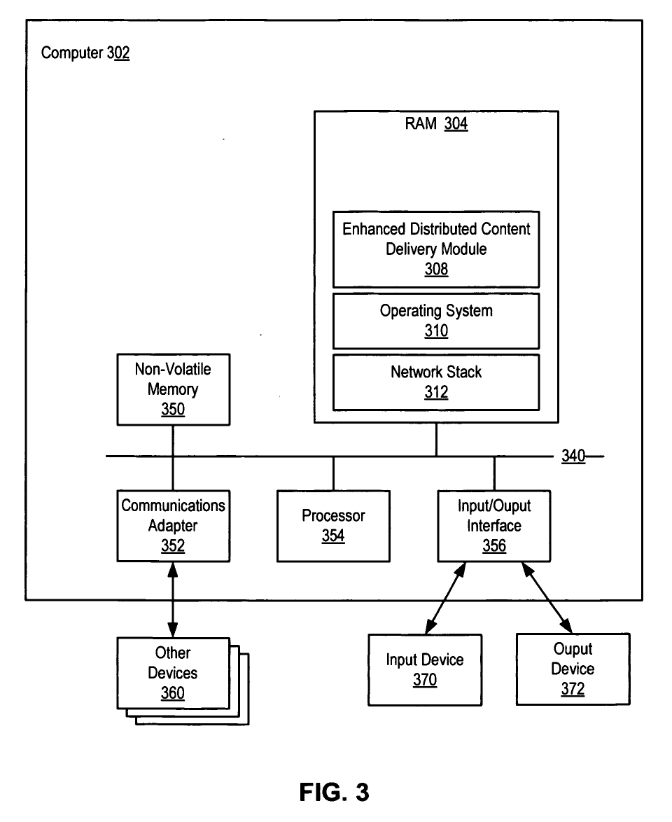

FIG. 3 sets forth a block diagram of an exemplary computer used in embodiments of the present disclosure. Computer 302 includes at least one computer processor 354 as well as a computer memory, including both volatile random access memory (‘RAM’) 304 and some form or forms of non-volatile computer memory 350 such as a hard disk drive, an optical disk drive, or an electrically erasable programmable read-only memory space (also known as ‘EEPROM’ or ‘Flash’ memory). The computer memory is connected through a system bus 340 to the processor 354 and to other system components. Thus, the software modules are program instructions stored in computer memory.

An operating system 310 is stored in computer memory. Operating system 310 may be any appropriate operating system such as Windows XP, Windows Vista, Windows 7, Windows Server, Mac OS X, UNIX, LINUX, or AIX. A network stack 312 is also stored in memory. The network stack 312 is a software implementation of cooperating computer networking protocols to facilitate network communications.

Computer 302 also includes one or more input/output interface adapters 356. Input/output interface adapters 356 may implement user-oriented input/output through software drivers and computer hardware for controlling output to output devices 372 such as computer display screens, as well as user input from input devices 370, such as keyboards and mice.

Computer 302 also includes a communications adapter 352 for implementing data communications with other devices 360. Communications adapter 352 implements the hardware level of data communications through which one computer sends data communications to another computer through a network.

Also stored in computer memory is an enhanced distributed content delivery module 308. The enhanced distributed content delivery module 308 may include device-specific computer program instructions for implementing methods of the present invention. For example, enhanced distributed content delivery module 308 may be implemented, in part, as a web browser application running on a client device operated by a user.

Enhanced distributed content delivery module 308 may also be implemented, in part, as server applications, such as, for example, ASP.NET 2.0, AJAX, MS SQL 2005. On each of source device 202, 203, media delivery network servers 204, regional database servers 206, and data server units 208 or regional cloud storage 209, enhanced distributed content delivery module 308 has different functionality.

The enhanced distributed content delivery module on regional database servers 206 operates to transmit content as described above with reference to FIGS. 2A-2E (e.g., receiving and serving playlist files). The module 308 may be embedded or installed on regional database servers 206.

The enhanced distributed content delivery module 308 may include processing module 205,205a, 205b, 205c. The enhanced distributed content delivery module on media delivery network servers 204 may operate to process content as described above with reference to FIGS. 2A-2E (e.g., segmenting, encoding, etc.). Enhanced distributed content delivery module 308 may include a processing module including encoders adapted to encode MPEG-4 frames as .ts files encoded to multi-device formats and tagged by device format. The module 308 may be embedded or installed on media delivery network servers 204. The module 308 may manage and implement control requests and notifies class drivers on a client device to any data transfer of video segmented frames; and transmits data into a network server container using a standard mpeg-2 transport stream file format. The module 308 may be adapted so that data ingest of the bitrate data file may be multi-threaded encoded and published to the cloud, directly or through regional database servers 206.

In other implementations, the module 308 may be installed or embedded on a source device 202, 203, including a recording or capturing device, such as a camcorder. The module may include a set of application modules that manages the recording or capturing device. A capturing application stack operates in conjunction with a corresponding host stack on another system to which the device is connected. The system is designed to manage multiple controllers, implement standard control requests and notify the class drivers of any, data transfers initiated by the Host. It provides the necessary abstraction to the class drivers, and interfaces with the controller hardware driver to provide data transfer services over IP capable of a programmable, multiple level response to threshold events received by the capturing application stack embedded on the network camera, input source of satellite feed, third party device enable, or any other typical input.

An application containing the capturing stack embedded on the camera may contain a segmenter trigger module designed to segment object container video frames according to a segmentation strategy, and a strategy model which is programmed and/or configured to adapt the segmentation strategy depending on the network conditions. The module may segment video streams into variable second chunks which may be published using a standard MPEG-2 transport stream file format. To maximize the efficiency of the system from affecting network bandwidth, capture functions may be configured to transmit frames and/or a “video stream” to a network server via standard digital I/O connections on the system (which may have video publishing triggering capabilities).

In some embodiments, a standard web browser (such as web browsers that support standard HTTP protocols and are supported by Microsoft Windows operating systems) may be used for all functions, including rendering of the content at the user device. For rendering, this browser may be a stand-alone browser, in that it includes no special software for rendering the content such as applets, applications, plug-ins, or players (for example, QuickTime, Flash Player, and the like). This ubiquitous rendering feature notwithstanding, for browser-based access software, camera specific ActiveX controls/Java Applets may be automatically loaded on the end-user device system in some implementations.

The module may manage multiple controllers, implement standard control requests and notify the class drivers of any data transfers initiated by the Host. The module may also provide the necessary abstraction to the class drivers, and interfaces with the controller hardware driver to provide data transfer services over IP. The API facilitates implementation of all of the necessary initialization and callback functions. The Progressive Camera Compression system includes a device stack and controller driver (when available) or a driver development kit. Device side class drivers may support specific cam device types so that the host can recognize and enumerate these devices when they are attached. Available class drivers may include Mass Storage, CDC Abstract Control Model (Serial Emulation) and Ethernet Emulation for Windows connectivity.

For live events, the module responds to changes in network conditions by adjusting the bitrate and the media encoding sequence to optimize the viewing and audio experience of the user.

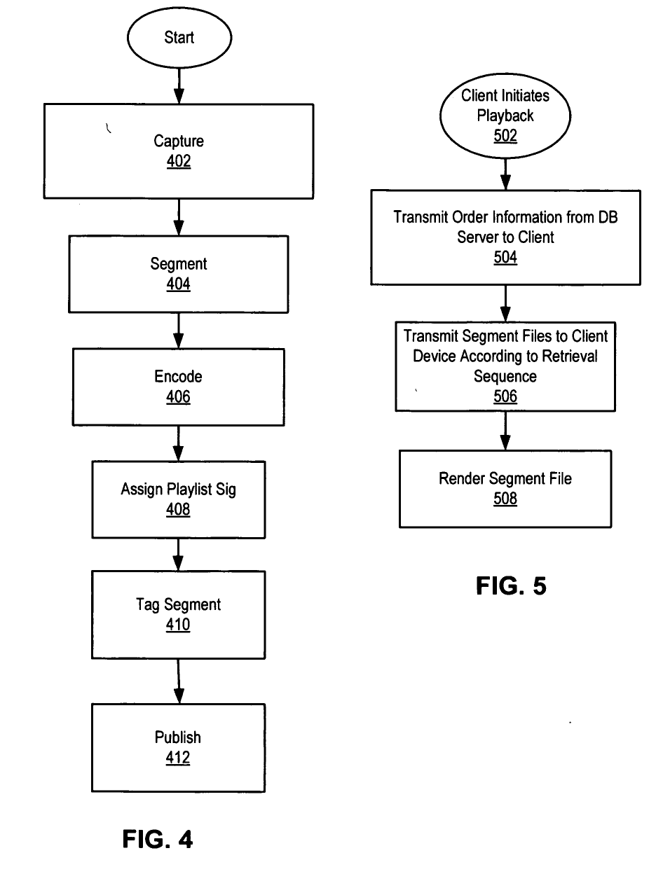

For further explanation, FIG. 4 sets forth a block diagram illustrating a method for enhanced distributed media delivery in accordance with one embodiment of the invention. Referring to FIG. 4, the method begins by capturing media content output (block 402). After capture, the content is segmented (block 404) and encoded (block 406). Encoding may comprise multi-thread encoding. Encoding of segment frames may involve encoding to four formats and publishing to the cloud. For live events, continuous uploading of a data file can quickly be done if data packets are small and uploaded one at a time. Next, the system assigns a playlist signature to the segments (block 408) and tags the segments according to frame (block 410). The segments are then published to the cloud (block 412).

Once the data is published, a user may select media by clicking on a link in a web browser. In response, the web browser downloads a playlist from a network server which redirects the browser to a data packet of playlist files in cloud storage, where it is viewed from cache memory. Some implementations include variations of progressive Hypertext Transfer Protocol (‘HTTP’), where users would request a playlist and retrieve a dynamically generated cache playlist for use in viewing live or on-demand media on any web-enabled device. Transcoding playlist techniques are used, similar to U.S. patent application Ser. No. 12/125,407 to Lee. However, techniques of the present embodiment include segmenting files to encode and publish to cloud file storage. Additionally, playlists are system compiled and encrypted to upload contents to the cloud. Once a user clicks on an HTTP link in a browser, the playlist obtained from the network server redirects to the data packet playlist files from the cloud and views the cache copy. Thus, the platform formats to device player requirements for delivery via HTTP, so no additional downloads, plug-ins, or apps are required.

The HTTP links are directed at frames uploaded to the cloud which play in HD from an embedded player code. The frames may be less than a minute in duration. The playlist requests instruct the cloud file storage to load the playlist in order: playlistset1, then playlistset2, playlistset4 and so on. The system programs the list to operate on retrieving published files from the cloud and playing them in sequence order: playlistset1 retrieves segment pulled from http://cloudfilecontainer1, playlistset2 retrieves segment pulled from http://cloudfilecontainer2; and so on. Cloud distribution allows multiple users to access the playlist at different times and pickup cache playlist copies—minimizing network bandwidth weight on the network server and on the stream.

The processing module 205 may be configured to process the captured output to achieve constant or relatively constant quality of variable bit rate output upon transmission to the client. The client may be configured to receive transmitted converted output and execute, decode, and/or render graphics, video, and/or audio on the client device. The processing module 205 may be further configured to process the captured output in order to provide either compressed file size or lower overall average bit rate at low latency. The data may be partitioned into variable-size chunks.

FIG. 5 sets forth a block diagram illustrating a method for enhanced distributed media delivery in accordance with one embodiment of the invention. Referring to FIG. 5, the method begins by transmitting the order information from the database server to a client on a client device (block 504) in response to the client initiating playback of the content (block 502). The order information is configured to serially generate a request for each segment in a retrieval sequence corresponding to the playback order upon being processed by the client. In response to receiving a request from the client device at the networked storage, the system transmits the stored segment files to a client device according to the retrieval sequence (block 506), where the client device will render the segment files according to the retrieval sequence (block 508).

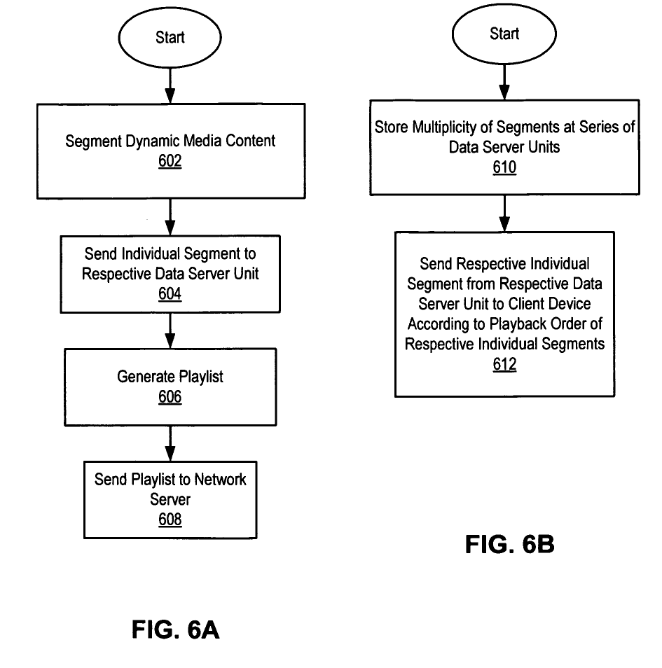

FIGS. 6A and 6B set forth a block diagram illustrating a method for enhanced distributed media delivery in accordance with one embodiment of the invention. Referring to FIG. 6A, the method begins by generating a multiplicity of segments by segmenting the dynamic media content (block 602) and sending each respective individual segment to its respective data server unit for storage (block 604). The multiplicity of segments taken together comprise a totality of information comprising the dynamic media content. The method also includes the step of analyzing the dynamic media content to determine playback characteristics and generating the playlist according to the playback characteristics, without regard for the multiplicity of segments (block 606); and sending the playlist to the network server (block 608).

Referring to FIG. 6B, the method continues by storing a multiplicity of segments at a series of data server units (block 610), with each segment containing a portion of a dynamic media content. Each data server unit comprises a data storage containing a respective individual segment; and a database server configured to deliver the respective individual segment for transmission to the client device. After storing the segments, the method continues by sending each respective individual segment from its respective data server unit to the client device according to a playback order of the respective individual segments (block 612). The receipt and native processing of the respective individual segments by the client results in rendering a reconstitution of the dynamic media content.

In some embodiments, the client may comprise a web browser and each data server unit may include a web server. Sending each respective individual segment from its respective data server unit to the client device may be carried out by downloading the respective individual segment to the web browser in response to a Hypertext Transfer Protocol (HTTP) request from the browser. Embodiments of some methods of the invention may further include delivering to the web browser a playlist indicating the playback order, wherein the playlist is configured to be natively processed by the web browser. In natively processing the playlist with the browser, the execution may direct the web browser to initiate HTTP requests for the respective individual segments to corresponding data server units according to the playback order; download the respective individual segments from the corresponding data server units according to the playback order; and render the respective individual segments according to the playback order so as to render a reconstitution of the dynamic media content.

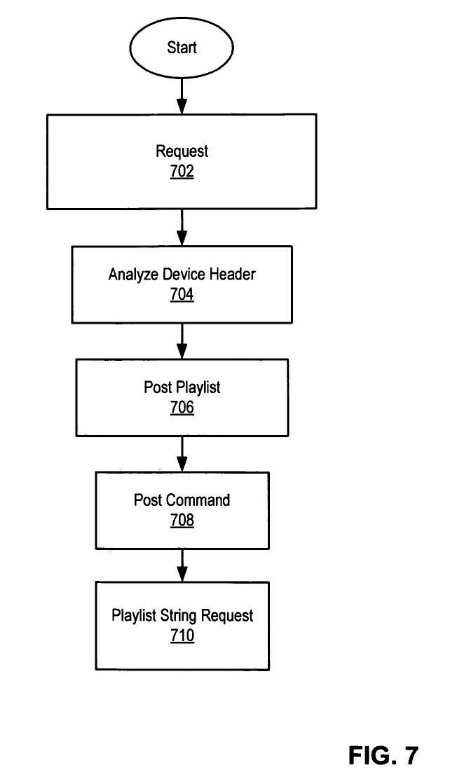

FIG. 7 sets forth a block diagram illustrating a method for enhanced distributed media delivery in accordance with one embodiment of the invention. Referring to FIG. 7, a user request to view a playlist link (block 702). A request command is issued. The request is sent to the server, where the bitrate controller analyzes the device header (block 704). The post playlist command publishes the playlist to the user (block 706). The Post command redirects the user to published playlist in cloud storage and retrieves frame sequence defined in the device header (block 708). The playlist string request command calls sequence frame from cloud storage container and posts live video (block 710).

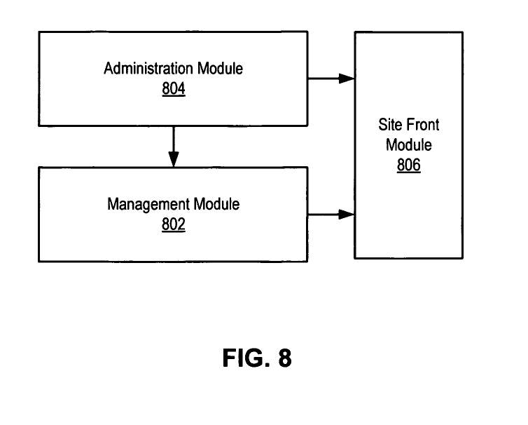

FIG. 8 sets forth a block diagram illustrating a method for enhanced distributed media delivery in accordance with one embodiment of the invention. The system of FIG. 8 includes a dynamically scalable broadcasting and flexible media consumption platform. The platform includes a management server 802, administration module 804, and the site front module 806. A management server module 802 provides the management and control functions for media delivery jobs by the system administrator and the stream owner members portal. The management server module 802 may be a web based customized management server specially designed for media companies to provide and configure streaming jobs of their dynamic media contents coming from Live or Recorded video sources. The management server module 802 may have Wizard-based setup options for media companies in which they will be able to define their content delivery jobs step-by-step. Media companies may be able to create new jobs for delivery, manage their existing jobs for delivery, or delete jobs. Different revenue models may be pre-packaged for graphical selection at the time of new streaming content job definition. The management server module 802 is responsible for the content delivery jobs management; accounting and billing; and account management.

Administration module 804 enables administration by the system administrator of customer interfaces along with any other operations regarding the media delivery server and revenue collection, such as job queue management, revenue model definition, customer account management, (stopping/resuming memberships and customer relations management), and articles and contents management for the site front. The site front module 806 includes a general lead generation portal delivering web-based articles and a registration area for both content-consuming and content-generating customers. The site front may also include registration and login facilities for consumer access.

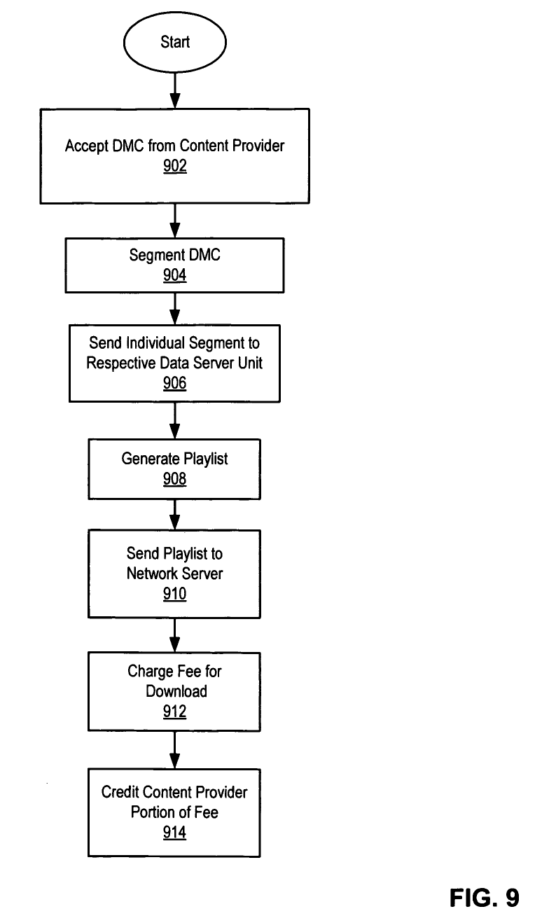

FIG. 9 sets forth a block diagram illustrating a method for enhanced distributed media delivery in accordance with one embodiment of the invention. The method of FIG. 9 illustrates the operation of a dynamically scalable broadcasting and flexible media consumption platform according to one embodiment. The dynamically scalable broadcasting and flexible media consumption platform is made possible by the enhanced delivery methods described above. The method begins by accepting dynamic media content from a content provider (block 902) and generating a multiplicity of segments by segmenting the dynamic media content (block 904) and sending each respective individual segment to its respective data server unit for storage (block 906). The method continues by generating a playlist (block 908) and sending the playlist to a network server (block 910). Finally, the platform charges a fee for downloading the respective individual segments to the web browser (block 912) and, optionally, crediting the content provider a portion of the fee (block 914). Charging the fee may include charging the content provider the fee, charging a consumer the fee, or any other fee arrangement as will occur to those of skill in the art. Charging the fee may be carried out on a per-account basis, on a per-occurrence basis, a per-device basis, or any other scalable fee basis, including as combined with tiered or flat-fee models. In some implementations, the per-use fee is the only fee charged.

The cloud file is a video file that may be comprised solely of binary data. The application will treat each byte as a value and output a stream of values between 0 and 255. The application interprets the values as colors and displays the corresponding picture. The cloud file contains frames. Each frame is comprised of pixels with x, y and RGBA values. RGBA values are typically expressed using 8 hexadecimal digits, with each pair of the hexadecimal digits representing the sample values of the Alpha, Red, Green and Blue channel, respectively. For example, 0x80FFFF00 represents 50.2% opaque (non-premultiplied) yellow. The “0x” prefix is used to identify a number as hexadecimal in C notation. The notation 0x80 represents a 50.2% alpha (opacity) value, because it is 50.2% of 0xFF (in decimal 128 is 50.2% of 255). The first 0xFF represents the maximum value a base color sample can have (e.g., red and green); 0x00 represents the minimum value a blue sample can have (e.g., blue). Thus, a mixture of only red and green yields yellow.

Embodiments of the present invention include design structures. Such embodiments may be contained on one or more machine readable media as a text file or a graphical representation of hardware embodiments of the invention. Typically, planning design structures are provided as input to design processes used in semiconductor design, manufacture, and/or test, to generate manufacturing design structures, with the exact processes used depending on the type of integrated circuit (‘IC’) being designed, such as an application specific IC ('ASIC), a standard component, and so on. A first design structure may be input from an IP provider, core developer, or any other source. A first design structure may include an embodiment of the invention in the form of schematics or a hardware-description language (‘HDL’), e.g., Verilog, VHDL, C, etc. Design processes may be used to translate an embodiment of the invention into a netlist, e.g., a list of wires, transistors, logic gates, control circuits, I/O, models, and so on. These processes may employ automation tools and applications, and may include inputs from a library which may house a set of commonly used elements, circuits, and devices, including models, layouts, and symbolic representations. The netlist describes the connections to other elements and circuits in an IC design, and may also be disposed on a machine readable medium. A netlist may be composed iteratively depending on design specifications and parameters for the circuit.

The design process may translate a planning design structure into a manufacturing design structure that resides on a storage medium in a data format used for the exchange of layout data of integrated circuits (for example, data stored in a GDSII (GDS2), GL1, OASIS, or any other suitable manufacturing design structure format). The manufacturing design structure may comprise information such as, for example, test data files, design content files, manufacturing data, layout parameters, wires, levels of metal, vias, shapes, or any other data required by a semiconductor manufacturer to produce a hardware embodiment of the invention. A producer may then employ the manufacturing design structure in tape-out and manufacture.

The discussion above has focused primarily on embodiments of the invention for use with published segmented media files retrieved according to a modified progressive HTTP. Other embodiments may be used with other file types and data transfer methods. It should be understood that the inventive concepts disclosed herein are capable of many modifications. To the extent such modifications fall within the scope of the appended claims and their equivalents, they are intended to be covered by this patent.

1. A method for delivering dynamic media content to a client on a client device, the method comprising:
storing a multiplicity of segments at a series of data server units, each segment containing a portion of the dynamic media content, each data server unit comprising:
data storage containing a respective individual segment; and
a database server configured to deliver the respective individual segment for transmission to the client device;
sending each respective individual segment from its respective data server unit to the client device according to a playback order of the respective individual segments which results in rendering a reconstitution of the dynamic media content;
wherein the multiplicity of segments taken together comprise a totality of information comprising the dynamic media content.

2. The method of claim 1 wherein the client comprises a web browser and each data server unit further comprises a web server, and wherein sending each respective individual segment from its respective data server unit to the client device comprises downloading the respective individual segment to the web browser in response to a Hypertext Transfer Protocol (HTTP) request from the browser.

3. The method of claim 2 further comprising delivering to the web browser a playlist indicating the playback order, wherein the playlist is configured to be natively processed by the web browser, whereby the native processing directs the web browser to: initiate HTTP requests for the respective individual segments to corresponding data server units according to the playback order;
download the respective individual segments from the corresponding data server units according to the playback order; and
render the respective individual segments according to the playback order so as to render a reconstitution of the dynamic media content.

4. The method of claim 2 further comprising delivering to the web browser from a network server a playlist indicating the playback order, wherein the playlist is configured to be natively processed by the web browser, whereby the native processing directs the web browser to download the respective individual segments to the web browser.

5. The method of claim 4 further comprising:
prior to storing the multiplicity of segments, generating the multiplicity of segments by segmenting the dynamic media content and sending each respective individual segment to its respective data server unit for storage;
without regard for the multiplicity of segments, analyzing the dynamic media content to determine playback characteristics and generating the playlist according to the playback characteristics;
sending the playlist to the network server.

6. The method of claim 5 wherein analyzing the dynamic media content to determine playback characteristics and generating the playlist according to the playback characteristics comprises analyzing the dynamic media content to determine playback characteristics and generating the playlist according to the playback characteristics prior to generating the multiplicity of segments.

7. The method of claim 4 further comprising:
prior to storing the multiplicity of segments, accepting the dynamic media content from a content provider;
prior to storing the multiplicity of segments, generating the multiplicity of segments by segmenting the dynamic media content and sending each respective individual segment to its respective data server unit for storage;
generating the playlist;
sending the playlist to the network server;
charging a fee on a per-occurrence basis for downloading the respective individual segments to the web browser.

8. The method of claim 7 further comprising crediting the content provider a portion of the fee.

9. The method of claim 7 wherein charging the fee comprises charging the content provider the fee.

10. The method of claim 7 wherein charging the fee comprises charging a consumer the fee.

11. The method of claim 4 further comprising:
prior to storing the multiplicity of segments, accepting the dynamic media content from a content provider;
prior to storing the multiplicity of segments, generating the multiplicity of segments by segmenting the dynamic media content and sending each respective individual segment to its respective data server unit for storage;
generating the playlist;
sending the playlist to the network server;
charging a fee on a per-device basis for downloading the respective individual segments to the web browser.

12. The method of claim 4 further comprising:
prior to storing the multiplicity of segments, accepting the dynamic media content from a content provider;
prior to storing the multiplicity of segments, generating the multiplicity of segments by segmenting the dynamic media content and sending each respective individual segment to its respective data server unit for storage;
generating the playlist;
sending the playlist to the network server;
charging a fee on a per-account basis for downloading the respective individual segments to the web browser.

13. The method of claim 4 further comprising:
prior to storing the multiplicity of segments, generating the dynamic media content at a recording device;
prior to storing the multiplicity of segments, generating the multiplicity of segments by segmenting the dynamic media content and transmitting each respective individual segment from the recording device to its respective data server unit for storage;
generating the playlist;
sending the playlist to the network server.

14. The method of claim 1 wherein the dynamic media content comprises an analog signal, wherein sending each respective individual segment from its respective data serve unit to the client device is a many-to-one transmission model with respect to the client.

15. (canceled)

16. A system for delivering dynamic media content to a client on a client device,
wherein the dynamic media content is segmented into a multiplicity of segments with each segment containing a portion of the dynamic media content, and wherein the multiplicity of segments taken together comprise a totality of information comprising the dynamic media content, the system comprising:
a series of data server units, wherein each data server unit is configured to send a respective individual segment to the client device, each data server unit comprising: data storage containing the segment; and
a database server configured to deliver the respective individual segment for transmission to the client device.

17. The system of claim 16 wherein the client comprises a web browser and each data server unit further comprises a web server configured to download the respective individual segment to the web browser.

18. The system of claim 17 wherein the web server is configured to download the respective individual segment to the web browser in response to a Hypertext Transfer Protocol (HTTP) request from the browser.

19. The system of claim 18 further comprising a network server configured to deliver a playlist to the client device indicating a playback order of the respective individual segments which results in rendering a reconstitution of the dynamic media content, wherein the playlist is configured to be natively processed by the web browser, whereby the native processing directs the web browser to:
initiate HTTP requests for the respective individual segments to corresponding data server units according to the playback order;
download the respective individual segments from the corresponding data server units according to the playback order; and
render the respective individual segments according to the playback order so as to render a reconstitution of the dynamic media content.

20. The system of claim 16 further comprising a network server configured to deliver a playlist to the client device indicating a playback order of the respective individual segments which results in rendering a reconstitution of the dynamic media content.

21. (canceled)

22. A method for delivering dynamic media content to a client on a client device, the method comprising:
generating a multiplicity of segments by segmenting dynamic media content, wherein each segment contains a portion of the dynamic media content, and wherein the multiplicity of segments taken together comprise a totality of information comprising the dynamic media content;
sending each respective individual segment to one of a series of data server units for storage, wherein each data server unit is configured to send the respective individual segment to the client device, each data server unit comprising:
data storage containing the segment; and
a database server configured to deliver the respective individual segment for transmission to the client device;
without regard for the multiplicity of segments, analyzing the dynamic media content to determine playback characteristics and generating a playlist according to the playback characteristics, the playlist indicating a playback order of the respective individual segments which results in rendering a reconstitution of the dynamic media content; and
sending the playlist to a network server.

23. The method of claim 22, wherein the playlist is configured to be natively processed by a web browser, whereby the native processing directs the web browser to: initiate HTTP requests for the respective individual segments to corresponding data server units according to the playback order;
download the respective individual segments from the corresponding data server units according to the playback order; and
render the respective individual segments according to the playback order so as to render a reconstitution of the dynamic media content.

24. A method for enhanced distributed content network delivery, the method comprising:
accepting dynamic media content from a content provider;
generating a multiplicity of segments by segmenting dynamic media content, wherein each segment contains a portion of the dynamic media content, and wherein the multiplicity of segments taken together comprise a totality of information comprising the dynamic media content;
generating a playlist indicating a playback order of the respective individual segments which results in rendering a reconstitution of the dynamic media content; and
providing access to the content to individual client devices in exchange for an individual fee;
aggregating the individual fees;
charging the content provider a multiple of the aggregated individual fees.

25. (canceled)

26. (canceled)
